(19) United States
(12) Patent Application Publication
(10) Pub. No.: US 2026/0117923 A1
(43) Pub. Date: Apr. 30, 2026

(54) REMOVABLE DOOR STORAGE SYSTEM AND DEVICE

(71) Applicant: LANGE ORIGINALS, LLC, Salt Lake City, UT (US)

(72) Inventors: Carter Smith, Salt Lake City, UT (US); Tobin Gunderson, Salt Lake City, UT (US)

(73) Assignee: LANGE ORIGINALS, LLC, Salt Lake City, UT (US)

(21) Appl. No.: 19/373,483

(22) Filed: Oct. 29, 2025

Related U.S. Application Data
(60) Provisional application No. 63/713,496, filed on Oct. 29, 2024.

(51) Int. Cl. F16M 13/02

(52) U.S. Cl. CPC F16M 13/02

(57) ABSTRACT

Disclosed herein is a removable door storage device including a bracket that has a body. Attached to the body is a head and a base. The head includes a cap that has an upper pin and an upper brace. The upper brace attaches to both the cap and the head. The base includes a foot that has a lower pin and a lower brace. The lower brace attaches to both the foot and the base. Also disclosed is a removable door storage system that includes a back bracket and a front bracket. The front and the back bracket both include items attributed to the aforementioned removable door storage device.

### PRIORITY CLAIM

This application claims the priority and benefit of U.S. Provisional Patent Application No. 63/713,496 filed on Oct. 29, 2024, which is incorporated by reference in its entirety.

### BACKGROUND

The history of the removable vehicle door traces back to the inception of the automobile when early vehicle designs prioritized functionality and practicality over aesthetic considerations. The first automobiles, largely modeled after horse-drawn carriages, featured fixed body structures that constrained passenger accessibility and contributed to an inefficient use of space. As the automotive industry evolved, it became evident that enhancing passenger convenience and vehicle adaptability necessitated innovative design approaches, leading to the introduction of removable doors.

In the early 20th century, manufacturers began to explore designs that allowed for greater flexibility in vehicle architecture. Initial designs for removable doors were often simplistic, relying on basic latch and hinge mechanisms that facilitated detachment. However, these early systems were limited in terms of security and structural integrity, resulting in concerns regarding passenger safety. Moreover, the practicality of removing doors was often hindered by the cumbersome process involved, which deterred widespread adoption among consumers.

As the automotive industry progressed, the mid-20th century witnessed substantial advancements in engineering and materials science. These advancements paved the way for the development of more sophisticated removable door mechanisms, which enhanced both security and ease of use. For instance, the incorporation of quick-release fasteners and improved latch systems allowed users to remove and replace doors with greater efficiency, thereby increasing the practicality of removable designs. Additionally, the use of lightweight materials such as aluminum and advanced composites facilitated the construction of doors that could be easily handled without compromising structural integrity.

By the late 20th century, the removable vehicle door had become a more common feature in certain vehicle segments, particularly in off-road and utility applications. The growing popularity of outdoor recreational activities and the need for versatile vehicle designs drove the demand for removable doors that could accommodate diverse user needs. Consequently, manufacturers responded by designing vehicles with modular components that allowed for customizable configurations. This trend reflected a broader shift toward consumer-centric design philosophies within the automotive industry.

In the early 21st century, the automotive landscape was further transformed by the integration of technology and innovation. The advent of advanced engineering techniques, such as 3D modeling and computer-aided design, enabled manufacturers to optimize the design of removable doors, ensuring that they met stringent safety and performance standards. The focus on sustainability also emerged as a key driver of design choices, with many manufacturers prioritizing eco-friendly materials and manufacturing processes.

Furthermore, the rise of electric and autonomous vehicles has introduced new dimensions to the design of removable doors. In particular, the integration of smart technology has led to the development of automated mechanisms that facilitate the removal and installation of doors, enhancing user convenience and safety. These advancements have expanded the potential applications of removable vehicle doors, making them increasingly appealing to a wider range of consumers.

Despite these advancements, a persistent challenge remains in the realm of removable vehicle doors: the need for effective storage solutions once the doors are detached. The practicality of using removable doors is often compromised by the lack of designated spaces for their storage, which can pose logistical challenges for users. In many instances, vehicle owners may lack sufficient space to securely store removed doors, leading to potential damage or loss. Furthermore, the absence of organized storage solutions can result in operational inefficiencies, particularly for users who require quick access to their removable doors for various activities.

As the trend toward removable vehicle doors continues to gain traction, addressing the issue of storage is critical. The development of dedicated storage systems that ensure the protection, organization, and accessibility of removed doors will not only enhance user experience but also promote the broader adoption of removable door technology in vehicles. Thus, there exists a compelling need for innovative solutions that effectively meet this storage challenge while complementing the existing advancements in removable vehicle door design.

### SUMMARY OF THE DISCLOSURE

A removable door storage system and device

### BRIEF DESCRIPTION OF THE DRAWINGS

Non-limiting and non-exhaustive implementations of the disclosure are described with reference to the following figures, wherein similar reference numerals refer to similar parts throughout the various views unless otherwise specified. The advantages of the disclosure will become better understood with regard to the following description and accompanying drawings where:

FIG. 1 illustrates a front perspective view of a door storage bracket.

FIG. 2 illustrates a front perspective view of an anchored door storage bracket.

FIG. 3 illustrates a front perspective view of a door storage bracket system.

FIG. 4 illustrates a front perspective view of an anchored door storage bracket system.

In the following description of the disclosure, reference is made to the accompanying drawings, which form a part hereof, and in which are shown by way of illustration-specific implementations in which the disclosure may be practiced. It is understood that other implementations may be utilized, and structural changes may be made without departing from the scope of the disclosure.

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same or similar reference numbers are used throughout the drawings to refer to the same or similar parts. It is further noted that elements disclosed with respect to particular embodiments are not restricted to only those embodiments in which they are described. For example, an element described in reference to one embodiment or figure may be alternatively included in another embodiment or figure regardless of whether or not those elements are shown or described in another embodiment or figure. In other words, elements in the figures may be interchangeable between various embodiments disclosed herein, whether shown or not.

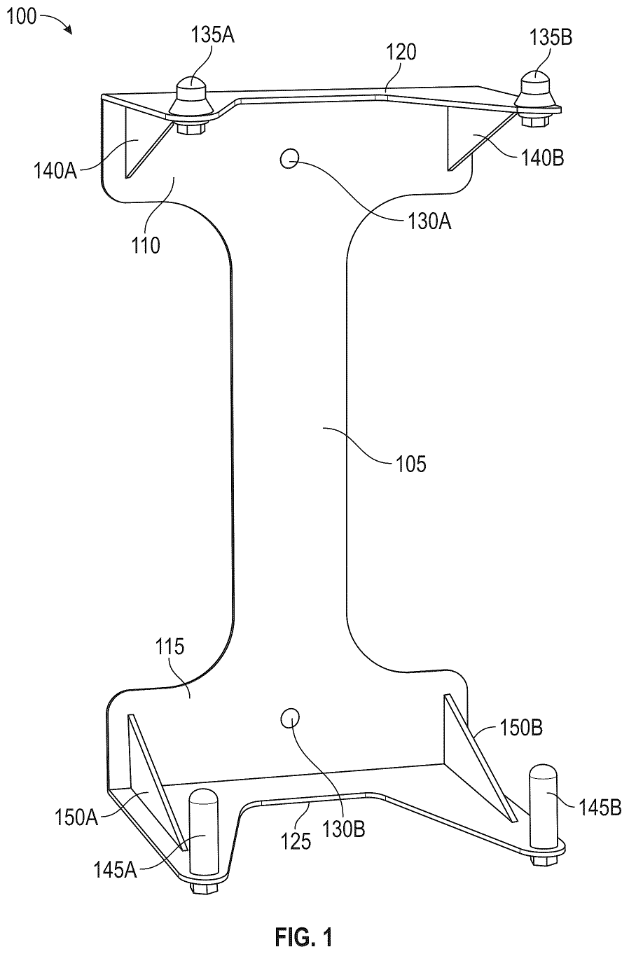

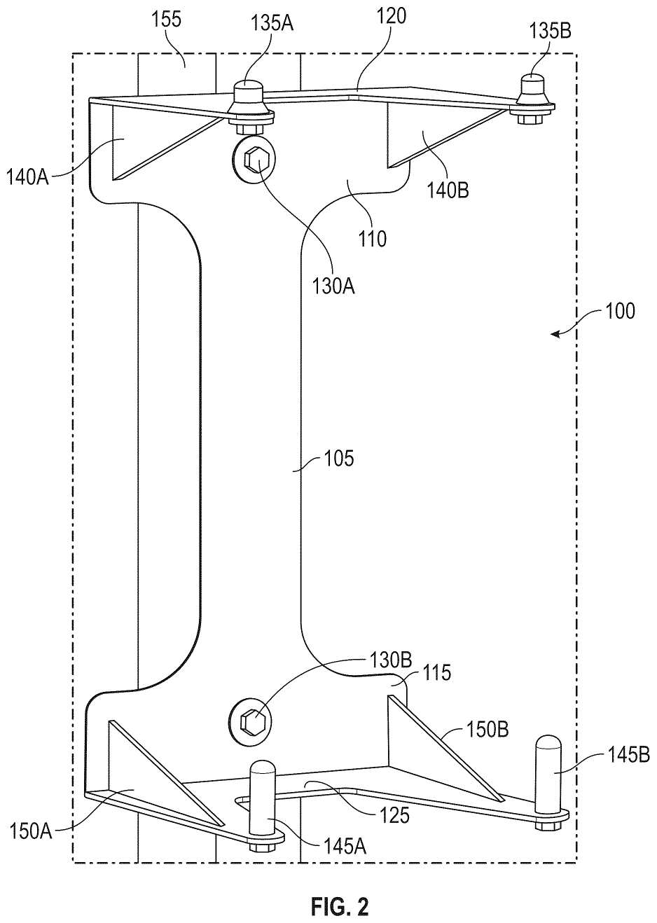

FIG. 1 illustrates a front perspective view of door storage bracket 100. Bracket 100 may include body 105, head 110, and base 115. Body 105 may connect to head 110 at one end and may connect to base 115 at another end. The length of head 110 may extend substantially perpendicular to the length of body 105. Substantially in this context means plus or minus 10%. Head 110 may include anchor point 130A which may be an aperture to receive a lag bolt or other attachment devices known in the art. Using anchor point 130A bracket 100 may attach directly to an anchor point such as a wall stud as depicted in FIG. 2.

Head 110 may also attach to cap 120 which may extend outward from the plane defined by body 105 and head 110 and base 115. Upper braces 140A-B may attach to the front side of head 110 and to the underside of cap 120. Cap 120 may also include upper pins 135A-B and may be attached near an outward edge in line with the upper braces 140A-B respectively. Upper pins 135A-B may extend in an upward direction. Further, upper pins 135A-B may be milled by a computer numerical control (“CNC”) machine from carbon steel or other materials with similar properties. The space between upper pin 135A and upper pin 135B may include a cut out of cap 120 such that a portion of cap 120 angles towards a center point from both pin 135A-B such that the two sides are angling towards one another.

Base 115 may also include anchor point 130B which may be an aperture to receive a lag bolt or other attachment devices known in the art. Base 115 may also attach to foot 125 and may extend outward from the plane defined by body 105 and head 110 and base 115. Foot 125 may extend outward substantially perpendicular to cap 120. Substantially in this context means plus or minus 10%. Lower braces 150A-B may attach to the front side of base 115 and to the upper side of foot 125. Foot 125 may also include lower pins 145A-B and may be attached near an outward edge in line with the lower braces 150A-B respectively. Lower pins 145A-B may extend in an upward direction. Further, lower pins 145A-B may be milled by a computer numerical control (“CNC”) machine from carbon steel or other material(s) with similar properties. The space between lower pin 145A and upper pin 145B may include a cut out of foot 125 such that a portion of foot 125 angles towards a center point from both lower pins 145A-B such that the two sides are angling towards one another.

Upper pin 135A may be positioned above lower pin 145A such that a removable door may attach to bracket 100 on upper pin 135A and lower pin 145A. The pins 135A and 145A may interact with apertures or other hinge parts existing on the removable door. The removable door once attached to pins 135A and 145A may extend in a direction opposite pins 135B and 145B. This may allow the removed door to rest lengthwise along the wall.

Similarly, Upper pin 135B may be positioned above lower pin 145B such that a removable door may attach to bracket 100 on upper pin 135A and lower pin 145B. The pins 135B and 145B may interact with apertures or other hinge parts existing on the removable door. The removable door once attached to pins 135B and 145B may extend in a direction opposite pins 135A and 145A. This may allow the removed door to rest lengthwise along the wall to which bracket 100 is attached. Further bracket 100 may include a protective coating to prevent damage to the removed doors.

FIG. 2 illustrates a front perspective view of door storage bracket 100. Bracket 100 may include body 105, head 110, and base 115. Body 105 may connect to head 110 at one end and may connect to base 115 at another end. The length of head 110 may extend substantially perpendicular to the length of body 105. Substantially in this context means plus or minus 10%. Head 110 may also include anchor point 130A which may be an aperture to receive a lag bolt or other attachment devices known in the art. Using anchor point 130A bracket 100 may attach to an anchor point such as wall stud 155.

Head 110 may also attach to cap 120 which may extend outward from the plane defined by body 105 and head 110 and base 115. Upper braces 140A-B may attach to the front side of head 110 and to the underside of cap 120. Cap 120 may also include upper pins 135A-B and may be attached near an outward edge in line with the upper braces 140A-B respectively. Upper pins 135A-B may extend in an upward direction. Further, upper pins 135A-B may be milled by a computer numerical control (“CNC”) machine from carbon steel. The space between upper pin 135A and upper pin 135B may include a cut out of cap 120 such that a portion of cap 120 angles towards a center point from both pin 135A-B such that the two sides are angling towards one another.

Base 115 may also include anchor point 130B which may be an aperture to receive a lag bolt or other attachment devices known in the art. Base 115 may also attach to foot 125 and may extend outward from the plane defined by body 105 head 110 and base 115. Foot 125 may extend outward substantially perpendicular to cap 120. Substantially in this context means plus or minus 10%. Lower braces 150A-B may attach to the front side of base 115 and the upper side of foot 125. Foot 125 may also include lower pins 145A-B and may be attached near an outward edge in line with the lower braces 150A-B respectively. Lower pins 145A-B may extend in an upward direction. Further, lower pins 145A-B may be milled by a computer numerical control (“CNC”) machine from carbon steel. The space between lower pin 145A and upper pin 145B may include a cut out of foot 125 such that a portion of foot 125 angles towards a center point from both lower pins 145A-B such that the two sides are angling towards one another.

Upper pin 135A may be positioned above lower pin 145A such that a removable door may attach to bracket 100 on upper pin 135A and lower pin 145A. The pins 135A and 145A may interact with apertures or other hinge parts existing on the removable door. The removable door once attached to pins 135A and 145A may extend in a direction opposite pins 135B and 145B. This may allow the removed door to rest lengthwise along the wall to which bracket 100 is attached. The removed door may be able to swing back and forth using pins 135A and 145A as hinge points. Alternatively, pins 135A and 145A may be keyed such that the removed door will remain stationary once in position.

Similarly, Upper pin 135B may be positioned above lower pin 145B such that a removable door may attach to bracket 100 on upper pin 135B and lower pin 145B. The pins 135B and 145B may interact with apertures or other hinge parts existing on the removable door. The removable door once attached to pins 135B and 145B may extend in a direction opposite pins 135A and 145A. This may allow the removed door to rest lengthwise along the wall to which bracket 100 is attached. The removed door may be able to swing back and forth using pins 135B and 145B as hinge points. Alternatively, pins 135B and 145B may be keyed such that the removed door will remain stationary once in position. Further, bracket 100 may include a protective coating to prevent damage to the removed doors.

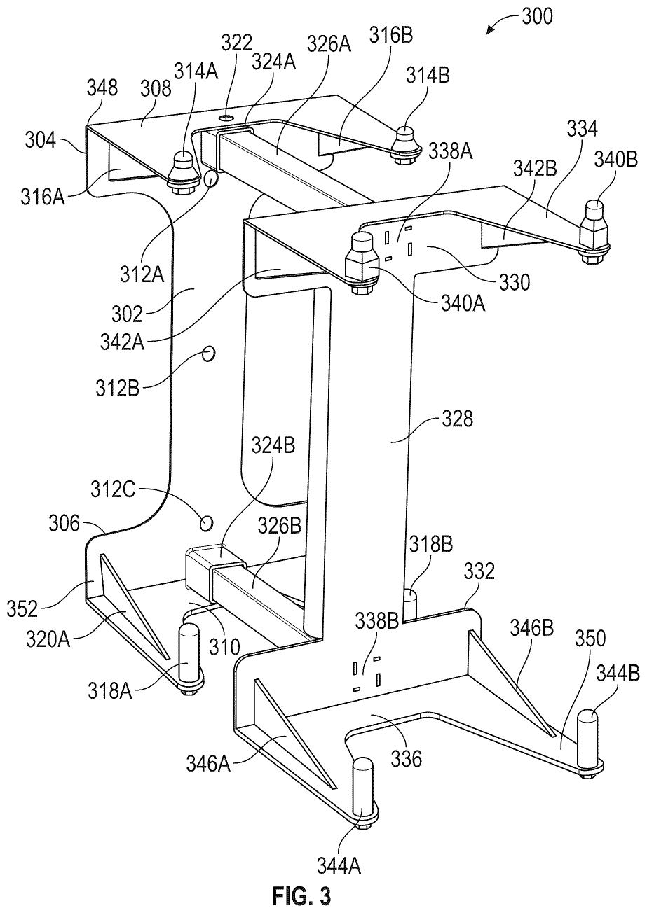

FIG. 3 illustrates a front perspective view of a door storage bracket system 300. System 300 may include back bracket 352 that attaches to front bracket 350. Back bracket 352 may include body 302 and may attach to head 304 at one end and attach to base 306 at another end. The length of head 304 may extend substantially perpendicular to the length of body 302. Substantially in this context means plus or minus 10%. Body 302 may attach to a center point of head 304 such that a portion of head 304 extends outward in opposite directions from where body 302 attaches to head 304. Moreover, body 302 widens in a curved manner at the attachment point between body 302 and head 304 such that there is a sloping transition between body 302 and head 304. The length of base 306 may extend substantially perpendicular to the length of body 302. Substantially in this context means plus or minus 10%. Body 302 may attach to a center point of base 306 such that a portion of base 306 extends outward in opposite directions from where body 302 attaches to base 306. Moreover, body 302 widens in a curved manner at the attachment point between body 302 and base 306 such that there is a sloping transition between body 302 and base 306.

Back Bracket 352 may include anchor points 312A-C that may be used to anchor system 300 to a wall. Anchor points 312A-C may be apertures and may be positioned along a center line of back bracket 352. Anchor point 312A may be positioned at the lower end of head 304 and in line with anchor points 312B-C and in a middle point between the left and right sides of head 304. Anchor point 312B may be positioned at a center point of body 302 and in line with anchor points 312A and 312C. Anchor point 312C may be positioned at the upper end of foot 306 and in line with anchor points 312A-B. Alternatively, one or more of anchor points 312A-B may be out of line with one or more of anchor points 312A-B.

Head 304 may also attach to cap 308 and may extend outward substantially perpendicular to the plane defined by body 302, head 304, and base 306. Substantially in this context means plus or minus 10%. Upper braces 316A-B may attach to the front side of head 304 and to the underside of cap 308. Cap 308 may also include upper pins 314A-B and may be attached near an outward edge in line with the upper braces 316A-B respectively. Upper pins 314A-B may extend in an upward direction. Further, upper pins 314A-B may be milled by a computer numerical control (“CNC”) machine from carbon steel or other material(s) with similar properties. The space between upper pin 314A and upper pin 314B may include a cut out of cap 308 such that a portion of cap 308 angles towards a center point between pin 314A-B such that the two sides are angling towards one another.

Head 304 may also include sleeve 324A that may attach to head 304, cap 308, and bridge 326A. Sleeve 324A may attach at its back end to head 304 and the top side of sleeve 324A may attach to cap 308. Cap 308 may also include pin 322 that may extend through apertures in cap 308, sleeve 324A, and bridge 326A allowing bridge 326A to be removably attached to back bracket 352. Pin 322 may be connected to a cable attached to front bracket 350. Bridge 326A may be sized to fit inside sleeve 324A. Alternatively, pin 322 may tighten down on bridge 326A not through an aperture but on the side of bridge 326A as to press bridge 326A to the bottom portion of sleeve 324A to better secure bridge 326A in place.

Base 306 may also attach to foot 310 which may extend outward substantially perpendicular to the plane defined by body 302 and head 304 and base 306. Substantially in this context means plus or minus 10%. Foot 310 may extend outward substantially perpendicular to cap 308. Substantially in this context means plus or minus 10%. Lower braces 320A-B (320B not seen due to perspective) may attach to the front side of base 306 and to the upper side of foot 310. Foot 310 may also include lower pins 318A-B and may be attached near an outward edge in line with the lower braces 320A-B (320B not seen due to perspective) respectively. Lower pins 318A-B may extend in an upward direction. Further, lower pins 318A-B may be milled by a computer numerical control (“CNC”) machine from carbon steel or other material(s) with similar properties. The space between lower pin 318A and upper pin 318B may include a cut out of foot 310 such that a portion of foot 310 angles towards a center point from both lower pins 1318A-B such that the two sides are angling towards one another.

Base 306 may also include sleeve 324B that may attach to base 306, foot 310, and bridge 326B. Sleeve 324B may attach at its back end to base 306 and the bottom side of sleeve 324B may attach to foot 310. Foot 310 may also include a pin (not seen due to perspective) that may extend through apertures in cap 308, sleeve 324A and bridge 326A allowing bridge 326A to be removably attached to back bracket 352. Bridge 326A may be sized to fit inside sleeve 324A. Alternatively, the pin may tighten down on bridge 326B not through an aperture but on a side of bridge 326B as to press bridge 326B to the upper portion of sleeve 324B to better secure bridge 326B in place.

Upper pin 314A may be positioned above lower pin 318A such that a removable door may attach to back bracket 352 on upper pin 314A and lower pin 318A. The pins 314A and 318A may interact with apertures or other hinge parts existing on the removable door. The removable door once attached to pins 314A and 318A may extend in a direction opposite pins 314B and 318B. This may allow the removed door to rest lengthwise along the wall to which back bracket 352 is attached. The removed door may be able to swing back and forth using pins 314A and 318A as hinge points. Alternatively, pins 314A and 318A may be keyed such that the removed door will remain stationary once in position.

Similarly, Upper pin 314B may be positioned above lower pin 318B such that a removable door may attach to back bracket 352 on upper pin 314A and lower pin 318B. The pins 314B and 318B may interact with apertures or other hinge parts existing on the removable door. The removable door once attached to pins 314B and 318B may extend in a direction opposite pins 314A and 318A. This may allow the removed door to rest lengthwise along the wall to which back bracket 352 is attached. The removed door may be able to swing back and forth using pins 314B and 318B as hinge points. Alternatively, pins 314B and 318B may be keyed such that the removed door will remain stationary once in position. Further, back bracket 352 may include a protective coating to prevent damage to the removed doors.

Front bracket 350 may include body 328 and may attach to head 330 at one end and attach to base 332 at another end. Bridges 326A-B may extend outwards and attach directly or indirectly to the back side of the front bracket 350. Bridges 326A-B may attach indirectly through sleeves similar to 324A-B. Bridge 326A may attach to head 330 at attachment point 338A and bridge 326B may attach to base 332 at attachment point 338B. The length of head 330 may extend substantially perpendicular to the length of body 328. Substantially in this context means plus or minus 10%. Body 328 may attach to a center point of head 330 such that a portion of head 304 extends outward from where body 328 attaches to head 330. Moreover, body 328 widens in a curved manner at the attachment point between body 328 and head 330 such that there is a sloping transition between body 328 and head 330. The length of base 332 may extend substantially perpendicular to the length of body 328. Substantially in this context means plus or minus 10%. Body 328 may attach to a center point of base 306 such that base 332 extends outward in opposite directions from where body 328 attaches to base 332. Moreover, body 328 widens in a curved manner at the attachment point between body 328 and base 332 such that there is a sloping transition between body 328 and base 332.

Head 330 may also attach to cap 334 that may extend outward from the plane defined by body 328 and head 330 and base 332. Upper braces 342A-B may attach to the front side of head 330 and to the underside of cap 334. Cap 334 may also include upper pins 340A-B and may be attached near an outward edge in line with the upper braces 342A-B respectively. Upper pins 340A-B may extend in an upward direction. Further, upper pins 340A-B may be milled by a computer numerical control (“CNC”) machine from carbon steel or other material(s) with similar properties. The space between upper pin 340A and upper pin 340B may include a cut out of cap 334 such that a portion of cap 334 angles towards a center point between upper pins 340A-B such that the two sides are angling towards one another.

Base 332 may also attach to foot 336 which may extend outward from the plane defined by body 328, head 330, and base 332. Foot 336 may extend outward substantially parallel to cap 334. Substantially in this context means plus or minus 10%. Lower braces 346A-B may attach to the front side of base 332 and to the upper side of foot 336. Foot 336 may also include lower pins 344A-B and may be attached near an outward edge in line with the lower braces 346A-B respectively. Lower pins 344A-B may extend in an upward direction. Further, lower pins 344A-B may be milled by a computer numerical control (“CNC”) machine from carbon steel or other material(s) known in the art. The space between lower pin 344A and lower pin 344B may include a cut out of foot 310 such that a portion of foot 336 angles towards a center point between lower pins 318A-B such that the two sides are angling towards one another.

Upper pin 340A may be positioned above lower pin 344A such that a removable door may attach to front bracket 350 on upper pin 340A and lower pin 344A. The pins 340A and 344A may interact with apertures or other hinge parts existing on the removable door. The removable door once attached to pins 340A and 344A may extend in a direction opposite pins 340B and 340B. This may allow the removed door to rest lengthwise and may extend parallel to doors attached to back bracket 352.

Similarly, Upper pin 340B may be positioned above lower pin 344B such that a removable door may attach to front bracket 350 on upper pin 340A and lower pin 344B. The pins 340B and 344B may interact with apertures or other hinge parts existing on the removable door. The removable door once attached to pins 314B and 318B may extend in a direction opposite pins 340A and 344A. This may allow the removed door to rest lengthwise and may extend parallel to doors attached to back bracket 352.

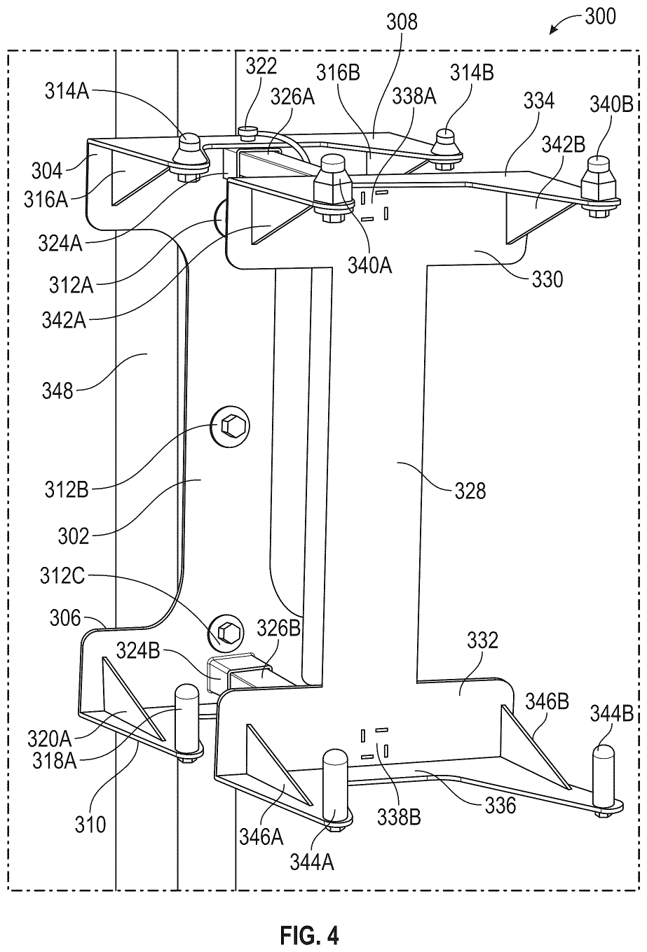

FIG. 4 illustrates a front perspective view of an attached door storage bracket system. System 300 may include back bracket 352 that attaches to front bracket 350. Back bracket 352 may include body 302 and may attach to head 304 at one end and attach to base 306 at another end. The length of head 304 may extend substantially perpendicular to the length of body 302. Substantially in this context means plus or minus 10%. Body 302 may attach to a center point of head 304 such that a portion of head 304 extends outward in opposite directions from where body 302 attaches to head 304. Moreover, body 302 widens in a curved manner at the attachment point between body 302 and head 304 such that there is a sloping transition between body 302 and head 304. The length of base 306 may extend substantially perpendicular to the length of body 302. Substantially in this context means plus or minus 10%. Body 302 may attach to a center point of base 306 such that a portion of base 306 extends outward in opposite directions from where body 302 attaches to base 306. Moreover, body 302 widens in a curved manner at the attachment point between body 302 and base 306 such that there is a sloping transition between body 302 and base 306.

Back Bracket 352 may include anchor points 312A-C that may be used to anchor system 300 to a wall stud 348. Anchor points 312A-C may be apertures and may be positioned along a center line of back bracket 352. Anchor point 312A may be positioned at the lower end of head 304 and in line with anchor points 312B-C and in a middle point between the left and right sides of head 304. Anchor point 312B may be positioned at a center point of body 302 and in line with anchor points 312A and 312C. Anchor point 312C may be positioned at the upper end of foot 306 and in line with anchor points 312A-B. Alternatively, one or more anchor points 312A-B may be out of line with one or more anchor points 312A-B.

Head 304 may also attach to cap 308 and may extend outward substantially perpendicular to the plane defined by body 302, head 304, and base 306. Substantially in this context means plus or minus 10%. Upper braces 316A-B may attach to the front side of head 304 and to the underside of cap 308. Cap 308 may also include upper pins 314A-B and may be attached near an outward edge in line with the upper braces 316A-B respectively. Upper pins 314A-B may extend in an upward direction. Further, upper pins 314A-B may be milled by a computer numerical control (“CNC”) machine from carbon steel or other material(s) with similar properties. The space between upper pin 314A and upper pin 314B may include a cut out of cap 308 such that a portion of cap 308 angles towards a center point between pin 314A-B such that the two sides are angling towards one another.

Head 304 may also include sleeve 324A that may attach to head 304, cap 308, and bridge 326A. Sleeve 324A may attach at its back end to head 304 and the top side of sleeve 324A may attach to cap 308. Cap 308 may also include pin 322 that may extend through apertures in cap 308, sleeve 324A, and bridge 326A allowing bridge 326A to be removably attached to back bracket 352. Pin 322 may be connected to a cable attached to front bracket 350. Bridge 326A may be sized to fit inside sleeve 324A. Alternatively, pin 322 may tighten down on bridge 326A not through an aperture but on the side of bridge 326A as to press bridge 326A to the bottom portion of sleeve 324A to better secure bridge 326A in place.

Base 306 may also attach to foot 310 which may extend outward substantially perpendicular to the plane defined by body 302 and head 304 and base 306. Substantially in this context means plus or minus 10%. Foot 310 may extend outward substantially perpendicular to cap 308. Substantially in this context means plus or minus 10%. Lower braces 320A-B (320B not seen due to perspective) may attach to the front side of base 306 and to the upper side of foot 310. Foot 310 may also include lower pins 318A-B and may be attached near an outward edge in line with the lower braces 320A-B (320B not seen due to perspective) respectively. Lower pins 318A-B may extend in an upward direction. Further, lower pins 318A-B may be milled by a computer numerical control (“CNC”) machine from carbon steel or other material(s) with similar properties. The space between lower pin 318A and upper pin 318B (318 B not seen due to perspective) may include a cut out of foot 310 such that a portion of foot 310 angles towards a center point from both lower pins 1318A-B such that the two sides are angling towards one another.

Base 306 may also include sleeve 324B that may attach to base 306, foot 310, and bridge 326B. Sleeve 324B may attach at its back end to base 306 and the bottom side of sleeve 324B may attach to foot 310. Foot 310 may also include a pin (not seen due to perspective) that may extend through apertures in cap 308, sleeve 324A, and bridge 326A allowing bridge 326A to be removably attached to back bracket 352. Bridge 326A may be sized to fit inside sleeve 324A. Alternatively, the pin may tighten down on bridge 326B not through an aperture but on a side of bridge 326B as to press bridge 326B to the upper portion of sleeve 324B to better secure bridge 326B in place.

Upper pin 314A may be positioned above lower pin 318A such that a removable door may attach to back bracket 352 on upper pin 314A and lower pin 318A. The pins 314A and 318A may interact with apertures or other hinge parts existing on the removable door. The removable door once attached to pins 314A and 318A may extend in a direction opposite pins 314B and 318B (318 B not seen due to perspective). This may allow the removed door to rest lengthwise along the wall to which back bracket 352 is attached. The removed door may be able to swing back and forth using pins 314A and 318A as hinge points. Alternatively, pins 314A and 318A may be keyed such that the removed door will remain stationary once in position.

Similarly, Upper pin 314B may be positioned above lower pin 318B (318 B not seen due to perspective) such that a removable door may attach to back bracket 352 on upper pin 314A and lower pin 318B. The pins 314B and 318B may interact with apertures or other hinge parts existing on the removable door. The removable door once attached to pins 314B and 318B may extend in a direction opposite pins 314A and 318A. This may allow the removed door to rest lengthwise along the wall to which back bracket 352 is attached. The removed door may be able to swing back and forth using pins 314B and 318B (318 B not seen due to perspective) as hinge points. Alternatively, pins 314B and 318B may be keyed such that the removed door will remain stationary once in position. Further, back bracket 352 may include a protective coating to prevent damage to the removed doors.

Front bracket 350 may include body 328 and may attach to head 330 at one end and attach to base 332 at another end. Bridges 326A-B may extend outwards and attach directly or indirectly to the back side of the front bracket 350. Bridges 326A-B may attach indirectly through sleeves similar to 324A-B. Bridge 326A may attach to head 330 at attachment point 338A and bridge 326B may attach to base 332 at attachment point 338B. The length of head 330 may extend substantially perpendicular to the length of body 328. Substantially in this context means plus or minus 10%. Body 328 may attach to a center point of head 330 such that a portion of head 304 extends outward from where body 328 attaches to head 330. Moreover, body 328 widens in a curved manner at the attachment point between body 328 and head 330 such that there is a sloping transition between body 328 and head 330. The length of base 332 may extend substantially perpendicular to the length of body 328. Substantially in this context means plus or minus 10%. Body 328 may attach to a center point of base 306 such that base 332 extends outward in opposite directions from where body 328 attaches to base 332. Moreover, body 328 widens in a curved manner at the attachment point between body 328 and base 332 such that there is a sloping transition between body 328 and base 332.

Head 330 may also attach to cap 334 which may extend outward from the plane defined by body 328 and head 330 and base 332. Upper braces 342A-B may attach to the front side of head 330 and to the underside of cap 334. Cap 334 may also include upper pins 340A-B and may be attached near an outward edge in line with the upper braces 342A-B respectively. Upper pins 340A-B may extend in an upward direction. Further, upper pins 340A-B may be milled by a computer numerical control (“CNC”) machine from carbon steel or other material(s) with similar properties. The space between upper pin 340A and upper pin 340B may include a cut out of cap 334 such that a portion of cap 334 angles towards a center point between upper pins 340A-B such that the two sides are angling towards one another.

Base 332 may also attach to foot 336 which may extend outward from the plane defined by body 328, head 330, and base 332. Foot 336 may extend outward substantially parallel to cap 334. Substantially in this context means plus or minus 10%. Lower braces 346A-B may attach to the front side of base 332 and to the upper side of foot 336. Foot 336 may also include lower pins 344A-B and may be attached near an outward edge in line with the lower braces 346A-B respectively. Lower pins 344A-B may extend in an upward direction. Further, lower pins 344A-B may be milled by a computer numerical control (“CNC”) machine from carbon steel or other material(s) known in the art. The space between lower pin 344A and lower pin 344B may include a cut out of foot 310 such that a portion of foot 336 angles towards a center point between lower pins 318A-B such that the two sides are angling towards one another.

Upper pin 340A may be positioned above lower pin 344A such that a removable door may attach to front bracket 350 on upper pin 340A and lower pin 344A. The pins 340A and 344A may interact with apertures or other hinge parts existing on the removable door. The removable door once attached to pins 340A and 344A may extend in a direction opposite pins 340B and 340B. This may allow the removed door to rest lengthwise and may extend parallel to doors attached to back bracket 352.

Similarly, Upper pin 340B may be positioned above lower pin 344B such that a removable door may attach to front bracket 350 on upper pin 340A and lower pin 344B. The pins 340B and 344B may interact with apertures or other hinge parts existing on the removable door. The removable door once attached to pins 314B and 318B (318 B not seen due to perspective) may extend in a direction opposite pins 340A and 344A. This may allow the removed door to rest lengthwise and may extend parallel to doors attached to back bracket 352.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered exemplary only, with a true scope and spirit of the invention being indicated by the following claims.

What is claimed is:

1. A removable door storage device comprising:
a bracket comprising:
a body;
a head attached to a first end of the body comprising:
a cap attached to the head comprising:
an upper pin;
an upper brace attached to both the head and the cap
a base attached to a second end of the body comprising:
a foot attached to the base comprising:
a lower pin; and
a lower brace attached to both the base and the foot.

2. The removable door storage device of claim 1, further comprises:
an anchor point.

3. The removable door storage device of claim 2, wherein the anchor point is positioned on the head.

4. The removable door storage device of claim 2, wherein the anchor point is positioned on the base.

5. The removable door storage device of claim 1, further comprises:
a first anchor point position on the head; and
a second anchor point positioned on the base.

6. The removable door storage device of claim 1, further comprises:
a second upper pin attached to the cap.

7. The removable door storage device of claim 6, wherein the upper pin is attached to a first end of the cap and the second pin is attached to a second end of the cap.

8. The removable door storage device of claim 7, wherein the cap contains a cutout such that a portion of the cap angles towards a center point between the upper pin at the first end of the cap and the second upper pin at the second end of the cap.

9. The removable door storage device of claim 1, further comprises:
a second lower pin attached to the cap.

10. The removable door storage device of claim 9, wherein the lower pin is attached to a first end of the cap and the lower second pin is attached to a second end of the cap.

11. The removable door storage device of claim 10, wherein the cap contains a cutout such that a portion of the cap angles towards a center point between the upper pin at the first end of the cap and the second pin at the second end of the cap.

12. A removable door storage system comprising:
a back bracket comprising:
a body;
a head attached to a first end of the body comprising:
a cap attached to the head comprising:
an upper pin;
an upper brace attached to both the head and the cap
a base attached to a second end of the body comprising:
a foot attached to the base comprising:
a lower pin; and
a lower brace attached to both the base and the foot
a front bracket connected to the back bracket;
a body;
a head attached to a first end of the body comprising:
a cap attached to the head comprising:
an upper pin;
an upper brace attached to both the head and the cap
a base attached to a second end of the body comprising:
a foot attached to the base comprising:
a lower pin; and
a lower brace attached to both the base and the foot.

13. The removable door storage system of claim 12, further comprises:
a bridge attached to the head of the back bracket on a first end and attaches to the head of the front bracket on a second end.

14. The removable door storage system of claim 13 further comprises:
a bridge attached to the base of the back bracket on a first end and attaches to the base of the front bracket on a second end.

15. The removable door storage system of claim 14, wherein the back bracket further comprises:
a sleeve attached to the head of the back bracket; and
a sleeve attached to the base of the back bracket.

16. The removable door storage system of claim 12, further comprises:
an anchor point.

17. The removable door storage system of claim 16, wherein the anchor point is positioned on the head.

18. The removable door storage system of claim 16, wherein the anchor point is positioned on the base.

19. The removable door storage system of claim 16, wherein the anchor point is positioned on the body.

20. The removable door storage system of claim 12, further comprises:
a first anchor point position on the head of the back bracket;
a second anchor point positioned on the base of the back bracket; and
a third anchor point is positioned on the body of the back bracket.
